(19) United States
(12) Patent Application Publication
(10) Pub. No.: US 2012/0331376 A1
(43) Pub. Date: Dec. 27, 2012

(54) INSERTING CONTENT IN ASSOCIATION WITH A WEB PAGE THAT IS TRANSMITTED TO A COMPUTING DEVICE

(75) Inventors: Jenia Gorokhovsky, Netanya (IL); Adi Belan, Tel Aviv (IL); Adi Weiser, Givatayim (IL); Yoav Weiss, Saint Donat sur I'Herbass (FR)

(73) Assignee: Flash Networks, LTD

(21) Appl. No.: 13/527,392

(22) Filed: Jun. 19, 2012

Related U.S. Application Data
(60) Provisional application No. 61/499,550, filed on Jun. 21, 2011.

(51) Int. Cl. G06F 17/00; G06F 15/16

(52) U.S. Cl. 715/234

(57) ABSTRACT

Web pages delivered to a mobile device having viewport functionality and modified to include toolbars that are automatically adjusted to conform to the characteristics of the mobile device and browser operating on the mobile device. As a ML file is transferred to the mobile device, the characteristics of the mobile device are identified and the toolbar is inserted into the ML file such that the toolbar will overlay a portion of the webpage and be visible to the user. The toolbar is inserted by using an US that can execute in the mobile device and detect changes or actions that result in modifying the display of the toolbar.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the United States provisional application for patent that was filed on Jun. 21, 2011 and assigned Ser. No. 61/499,550, which application is incorporated hereby by reference in its entirety. U.S. patent application Ser. No. 12/640,084 filed on Dec. 17, 2011 is hereby incorporated by reference.

### BACKGROUND

The present invention relates to the field of data communication and, more particularly, to a system and method for adding content in association with a web page that is presented to a surfer using a computing device.

The Internet is an exceedingly popular medium for data communication between computers. The Internet is a hierarchy of many computer networks, all of which are interconnected by various types of server computers. Some of the servers, interconnected through the Internet, also provide database housing or storage for a plurality of web pages. These web pages may be retrieved by users (also referred to as surfers) operating computers that are connected to the Internet and running browser applications or other applications that can access the web pages. As a non-limiting example, the browser applications could be applications such as: Openwave Systems Inc. or Opera Mobile Browser, Firefox Web Browser, GOOGLE CHROME, etc.

Many current web pages are defined by markup language (ML) files, such as but not limited to HTML, XML, WML, SGML, HDML etc. HTML is an acronym for Hyper Text Markup Language, XML is an acronym for Extensible Markup Language and WML is an acronym for Wireless Markup Language. SGML is an acronym for Standardized General Markup Language. HDML is an acronym for Handheld Device Markup Language. It should be noted that the terms “HTML”, “XML”, “SGML”, “HDML” and “WML” may be used interchangeably herein. Henceforth, throughout the disclosure the term ‘HTML’ may be used as a representative term for any of the various forms of markup languages unless specifically limited to a particular markup language.

An ML file contains various commands, instructions, data, scripting language code and references (links) that together define the overall appearance of a web page once it is fetched and rendered using a browser or other similar application. Common HTML files may comprise information that is relevant to the web page and that may be needed for rendering the requested web page. This information may include but is not limited to, a style sheet, text, images, scripting language code, such as JAVASCRIPT (JAVASCRIPT is a trademark of Oracle Corporation), links to a style sheet, links to JAVASCRIPT, links to additional objects, links to other web pages, etc. JAVASCRIPT is an example of ECMAScript. Throughout the description, the term JS is used as a representative term for a scripting language code. A web page can be composed from a plurality of objects or segments of the web page that together comprises the web page.

Usually, an HTML file comprises links to the above-described objects rather than comprising the objects themselves. This technique is widely implemented, thus most HTML files can include basic text and links to style sheets, JS, images, and other objects and rather than to include the complete style sheet or all of the objects themselves, etc. Objects that are used by the browser itself are referred as browser's objects. The links to the browser's objects are fetched automatically by the browser during parsing of the page—these links are referred as browser's links. Links such as but not limited to links to JS, to style sheets, and to images can be referred to as browser's links. Other links can be displayed on the surfer's screen for the surfer to select. Those links are referred as surfer's links or user's links. Exemplary surfer's links can be a link to another web page.

While surfing the World Wide Web (WWW), a surfer (a user), utilizing a browser equipped device, may send an HTTP (Hyper Text Transfer Protocol) request to a web server. In response, the web server may send an HTML file of the requested web page. HTML, ML file, HTTP, WWW are well known in the art and therefore they are not further described. A reader who wishes to learn more about them is invited to read in technical books.

Nowadays millions of users surf the Internet. A growing number of surfers use a handheld device or a mobile device, which can wirelessly surf the Internet and retrieve web pages. Exemplary mobile devices can be mobile telephones (cellular telephones, and smart phones—such as but not limited to the IPHONE (a trademark of Apple computers Inc), and so on, PDA (Personal Digital Assistants), tablet computers such as but not limited to IPAD (a trademark of Apple computers Inc), etc. In the disclosure, the above names may be used interchangeably and the term mobile device (MD) can be used as a representative term for the above group of devices as well as other devices with similar capabilities. Usually a mobile device has some limitation in comparison to a common computer (such as personal computer or a laptop). Exemplary limitations can be: a smaller screens, limited computing power, limited power supply, limited storage capabilities, limited keyboard capabilities, etc.

Thus, many different types of devices with varied capabilities can be used for accessing web content. As a non-limiting example, some devices may require content adaptation for surfing and accessing content, while other devices do not require content adaptation. In addition, there is a wide range of combinations of devices and browsers. Furthermore, there are different types of websites that can be accessed by a device. As a non-limiting example, a website can be a mobile-aware or mobile-cognizant website. Those of ordinary skill in the art will be understand that a mobile aware website is typically accessed using a URL that includes an ending of “.mobi”, or a URL starting with WAP instead of starting with WWW. Other website may be mobile device agnostic, meaning that they are not aware of the capabilities of mobile devices that may be accessing the website.

There are cases in which a service provider, which can be located over an intermediate node between the surfers and the web servers, would like to add content to a web page, on the fly (while transferring the webpage to a receiving device). For instance, the service provider may wish to include additional data in association with the requested web pages. The additional added data can be any of a variety of data, including a banner with a logo of the service provider, a link to other web pages, an advertisement, news, a surfer's bookmarks (the user's favorite websites), a surfer's toolbar, etc. as non-limiting examples Service provider may store the user's favorite web pages, and may handle the user's bookmarks, for example. The banner can be placed as a header at the top of the rendered web page or as footer at the bottom of the rendered web page, for example. Such capabilities can be used for informing a user of the mobile device about locale or current events, or to get the surfer's bookmarks that are stored at a cellular operator's premises, for example. Therefore adding data to a web page can help to improve the user's surfing experience.

However, due to the limitation of mobile devices and the huge number of different combinations of devices and browsers, as well as the number of different web pages and types of web pages that can be accessed, it can be complicated to add the additional data to a web page while it is transferred toward a surfer using a mobile device. A few common techniques that have been deployed for this capability use a common content adaptation server. A content adaptation server is a powerful and complicated machine, and consequently an expensive option to use. The content adaptation server intercepts the data transportation between a plurality of mobile devices and a plurality of web servers, processes and modifies the received web pages in order to adapt them to the particular combination of the type of mobile device and the type of browser being used by the mobile device that is requesting the pages and which is the destination of each of the web pages. Using a content adaptation server only for adding banners, footer or headers, to a web page is an expensive solution.

Another prior art system can add data to a requested web page in an intermediate node between a mobile device and a web site. This system intercepts the data traffic between the mobile device and the web site, identifies the capabilities of the mobile device, identifies a location in the requested web page that fits the added data and modifies the requested web page that is downloaded to the mobile device by adding the content to a frameset that wraps other framesets in the requested web page. Such a technique is disclosed in a U.S. patent application Ser. No. 12/640,084 filed on Dec. 17, 2011 and was published on Jul. 1, 2010 having US Pre Granted publication number 2010/0,169,763, the content of which is incorporate herein by reference.

### BRIEF SUMMARY

The mobile industry has seen the introduction of several modern mobile web browsers, such as but not limited to MOBILE SAFARI (trademark of Apple inc.), ANDROID BROWSER (a Trademark of Google Inc.), and other browsers that support HTML. 5.0 and other versions. With modern mobile devices, such as but not limited to the IPHONE and IPAD (trademarks of Apple Inc.), and NOKIA X7-00 or NOKIA E6-00 (a trademark of Nokia Finland), new features and capabilities have been made available for such mobile devices. As a non-limiting example, one such feature is the “Viewport” interface. Viewport allows viewing of regular web pages on a screen that is smaller than what was intended for the web page. By using Viewport, a portion of an area of an image or web page, wherein the image is larger than the physical visualization area of the device, is displayed over the visualization device. A browser having the Viewport capabilities renders a web page as if the screen size of the mobile device is capable for presenting the entire canvas of the web page, and then parts of the fully rendered page can be viewed through the Viewport. The user can move the Viewport to see different parts of the page, or resize it to control the size and location of a portion of the page to be displayed on the screen. Exemplary screen sizes for mobile devices can be 240×320 pixels (Width×Height, W×H), for example. However, exemplary screen sizes of a canvas of a downloaded web pages can be 1280×1024 pixels (Width×Height, W×H), for example.

Further, modern browsers and modern mobile devices enable the user to change the orientation of the mobile device from portrait to landscape and vice versa. Consequently, the presentation of the web page via the Viewport is changed accordingly.

By using the above described features of modern browsers and modern mobile devices, a user may change the size of the Viewport, the location of the Viewport, and the orientation locally, without informing the relevant web server about those changes. In addition, a toolbar may or may not be presented to the user without informing the web server. Thus, prior art methods that engage the rendering of a toolbar with a delivered web page are not useful when those modern features are used. A toolbar that is bundled into a web page by a prior art system, when it is presented by those modern browsers and mobile devices cannot be adapted to the user manipulation of the presentation of the webpage locally by using the Viewport capabilities and the mobile control capabilities. Further, today the HTML standards do not define how to create an association between the Viewport and the toolbar. There are no definitions in the standard for fixing a toolbar to a Viewport.

Furthermore, the content of a toolbar may contain a user's private information. As such, the toolbar information should be transferred and stored in a manner that would not allow the host page to access it. Throughout this description, the term toolbar is used as a representative term for any type of content that can be added by an intermediate node and be presented on a mobile device while rendering a web page. A banner can be presented in a similar way, for example.

The above-described deficiencies in presenting a toolbar over a rendered web page by using modern mobile devices and modern browsers is presented as a non-limiting example and should not limit the scope of the concepts and features presented in this disclosure in any manner. The deficiencies are merely presented for illustrating an existing situation.

An exemplary novel method and system can be implemented in an intermediate node for adding a toolbar to a web page that is sent toward a user's modern mobile device that utilizes a browser with Viewport capabilities. The added toolbar can be described by a toolbar script. The toolbar script can be an HTML code, which is inserted into the web page by the intermediate node. An exemplary toolbar script can include one or more iframes. The intermediate node can be located between a plurality of web servers and a plurality of mobile devices. An exemplary modern device may be a tablet smart phone such as, but not limited to an IPHONE or IPAD (trademarks of Apple Inc. USA), NOKIA X7-00 or NOKIA E6-00 (trademark of Nokia Finland), etc. An iframe is an inline frame that places another HTML document in a frame of a first HTML document. It should be noted that the terms toolbar script and an iframe that describes the toolbar can be used interchangeably.

An exemplary method may use one or more types of JS codes. A first JS code can be referred as Insertion JS (IJS) and a second JS code can be referred as a Toolbar JS (TJS). However, there are embodiments that may use only the IJS. A link to the IJS can be added to a web page that is downloaded to a surfer's mobile device. In one exemplary embodiment the US can be added by the web server that sends the web page. In another exemplary embodiment, the IJS can be added by an intermediate server that intercepts the data communication between the plurality of web servers and user's devices, such an intermediate server can be referred to as a Toolbar Insertion Server (TIS). The TIS can inject the US code into the body element of the web page. It can be injected before the end-of-body tag, </body>. In an alternate embodiment, a browser link can be inserted to the web page body. When a requesting browser parses the web page and reaches the inserted link, it will fetch the US code and execute it. In addition, the TIS may insert the toolbar HTML, the toolbar script, itself into the body of the web page. The toolbar script can comprise one or more links to iframes. The iframes are hidden iframes which are not visible and can be made visible only by the US code.

A first iframe link can be associated with a portrait toolbar that may be presented when the orientation of the mobile device is in a portrait orientation or the mobile device is operated in a portrait mode. A second iframe link can be associated with a landscape toolbar that may be presented when the orientation of the mobile device is in a landscape orientation or the mobile device is operated in a landscape mode. A third iframe link can be associated with a promotion that may be presented to the surfer, etc. During the presentment of the web page, only one of these iframes may be presented over the mobile device. The IJS determines which one to present. In some embodiment, each iframe can comprise a TJS that is related to its toolbar or a link to that TJS.

In some embodiments, the toolbar script, which is added to the HTML file that depicts the requested web-page, may contain the toolbar HTML directly without using the iframe configuration. However, using the iframe configuration can improve the isolation between the web-page and the toolbar. In an embodiment in which an iframe is not used, a single JS can be used for accomplishing the tasks of the US and the TJS.

In an alternate embodiment, a single iframe may be used. The single iframe may comprise the script for presenting the landscape toolbar, the portrait toolbar and the promotion. Yet in another embodiment, four iframes may be used. In the four iframe embodiments, one iframe is used for the landscape toolbar, one for the portrait toolbar, one for the landscape promotion and the last one for the portrait promotion. A person of ordinary skill in the art will appreciate that the number of iframes for presenting the toolbars does not limit the scope of the present disclosure.

The US, when it is activated by the requesting browser as part of processing the requested webpage, may implement the following task. It may verify that the inserted toolbar is located in the body of the web page itself. Thus, the toolbar will be presented in the web page that has been requested by the surfer and not in an iframe that may be related to a promotion, for example. If the toolbar is not in the body of the web page, then the US terminates its task without presenting the toolbar. If the US is located in the main iframe, then it verifies that the location of the inserted iframes is at the end of the body of the web page. If not, the IJS may transfer the one or more iframes of the toolbar to the end of the body, before the end-of-body tag. At this point, the IJS may wait to obtain an “on load” event informing that the browser completed the rendering process and now the toolbar can be presented.

The IJS may further register itself for being notified when certain events occurs, events that can affect the presentation of the toolbar. Exemplary events can be touch events for showing/hiding the toolbar and/or the promotion toolbar, changes in the Viewport such as size changes, moving the Viewport, orientation changes, etc. According to the different events, the IJS is responsible to communicate those events to the TJS in order to manipulate the presented toolbar accordingly.

A common web page and a toolbar are delivered from different domains. The web page may be delivered from a public web server that may serve a plurality of surfers that are serviced by different Internet Service providers (ISP) or different Network Access Providers (NAP). The toolbar is delivered from a unique server that is associated with a certain ISP or a certain NAP domain. This is referred to as the toolbar insertion server (TIS). Thus, because the web page and the iframe of the toolbar were delivered from different domains, they cannot share information. In order to enable the communication between the IJS and the TJS code, an exemplary embodiment may use the “postMessage” cross window protocol. In order to send and receive messages, the US and the TJS need to register as listeners for message events. In some embodiments the postMessage application program interface (API) may use a predefine authentication process. Authentication methods are well known in the art and will not be further described.

Further, an exemplary TIS and TJS may be configured to communicate with a web server by using AJAX technique for obtaining information from the web server. AJAX is acronym for Asynchronous JavaScript and XML. AJAX is technique used by With Ajax, web applications for sending data to, and retrieve data from, a server asynchronously without interfering with the display and behavior of the existing webpage. AJAX is well known in the art and will not be further described. In order to enable cross domain AJAX, the TJS can notify the TIS that the request is targeted to another web server, for example the web server of the current presented web page. This notification can be done by using a predefine expression. In addition, the association between the predefine expression and the prefix of each one of the other web servers may be configured in the TIS before the beginning of the session. An exemplary expression may be: <toolbar domain>/xdr?url=<target url>.

An exemplary TJS can control the toolbar presentation. It can update style parameters according to the presented web page, close the toolbar, etc. In addition, the TJS can be configured to get an indication from the IJS via the cross window messages (postMessage API), about the user touch gestures which manipulate the Viewport along the presented web page. The effect of the surfer's gesture on the location and size of the Viewport are processed and accordingly the location of the toolbar and the size of the toolbar are calculated and the toolbar layer is manipulated to match those changes. In a similar way, when the orientation of the mobile device is changed, the toolbar iframe is changed to the iframe that matches the new orientation, portrait or landscape.

The relevant iframe of the toolbar script (portrait, landscape or promotion) may be manipulated to have the size of the Viewport. Wherein the major portion of the toolbar iframe (90%, for example) is transparent and the minor bottom portion (10%) comprises the content of the toolbar, as a non-limiting example. The manipulated toolbar iframe data is transferred via the postMessage API to the IJS that presents the manipulated toolbar as the top layer of the presented web page.

In other embodiments, in which a single iframe is used, changing the orientation of the mobile device will lead the TJS to select an appropriate set of parameters for the toolbar that fits within or conforms to the new orientation. The set of parameters may be written in the single iframe together with the other set of parameters that fit the other orientation or the promotion.

Yet, in an alternate exemplary embodiment, the IJS may determine the orientation, size and location of the toolbar based on the current parameters of the viewport and accordingly may present the toolbar over the current viewport. In such an embodiment, the TJS may be used for informing and instructing the IJS based on the surfer's command, touches in the toolbar area.

Last but not the least, a toolbar in a mobile device is not a common feature, and typical users may not be aware of the new capabilities of presenting a web page with a toolbar on a modern mobile device. In order to inform the surfer, an exemplary embodiment may automatically present the toolbar on a presented web page with a toolbar having an icon for a surfer gesture for hiding and/or presenting the toolbar.

The foregoing summary is not intended to summarize each potential embodiment or every aspect or feature of all possible embodiments, and other features and advantages will become apparent upon reading the following detailed description of the embodiments with the accompanying drawings and appended claims.

Furthermore, although specific exemplary embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE SEVERAL VIEWS OF THE DRAWING

Exemplary embodiments of the present disclosure will be understood and appreciated more fully from the following detailed description, taken in conjunction with the drawings in which:

FIG. 1 illustrates a block diagram with relevant elements of an exemplary Access Network Operator Premises (ANOP) in which an exemplary embodiment of the present disclosure can be implemented in;

FIG. 2 illustrates a block diagram with relevant elements of an exemplary Toolbar-Insertion Server (TIS), according to the teaching of the present disclosure;

FIG. 3 illustrates a flowchart with relevant actions of an exemplary process for managing an exemplary TIS, according to teaching of the present disclosure;

FIG. 4 illustrates a flowchart with relevant actions of an exemplary process of handling an intercepted Markup Language (ML) file, according to teaching of the present disclosure;

FIG. 5 illustrates a flowchart with relevant actions of an exemplary process of handling the communication between a user device and the TIS, according to teaching of the present disclosure;

FIGS. 6a to 6c illustrates a flowchart with relevant actions of an exemplary process of a toolbar Insertion JS (IJS), according to teaching of the present disclosure; and

FIG. 7 illustrates a flowchart with relevant actions of an exemplary process of a toolbar JS (TJS), according to teaching of the present disclosure.

### DETAILED DESCRIPTION OF EMBODIMENTS OF THE INVENTION

Turning now to the figures in which like numerals represent like elements throughout the several views, exemplary embodiments of the present disclosure are described. For convenience, only some elements of the same group may be labeled with numerals. The purpose of the drawings is to describe exemplary embodiments and not for production. Therefore, features shown in the figures are chosen for convenience and clarity of presentation only. Moreover, the language used in this disclosure has been principally selected for readability and instructional purposes, and may not have been selected to delineate or circumscribe the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware. In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. Software of a logical module may be embodied on a computer readable medium such as a read/write hard disc, CDROM, Flash memory, ROM, or other memory or storage, etc. In order to execute a certain task a software program may be loaded to an appropriate processor as needed. In the present disclosure the terms task, method, process can be used interchangeably.

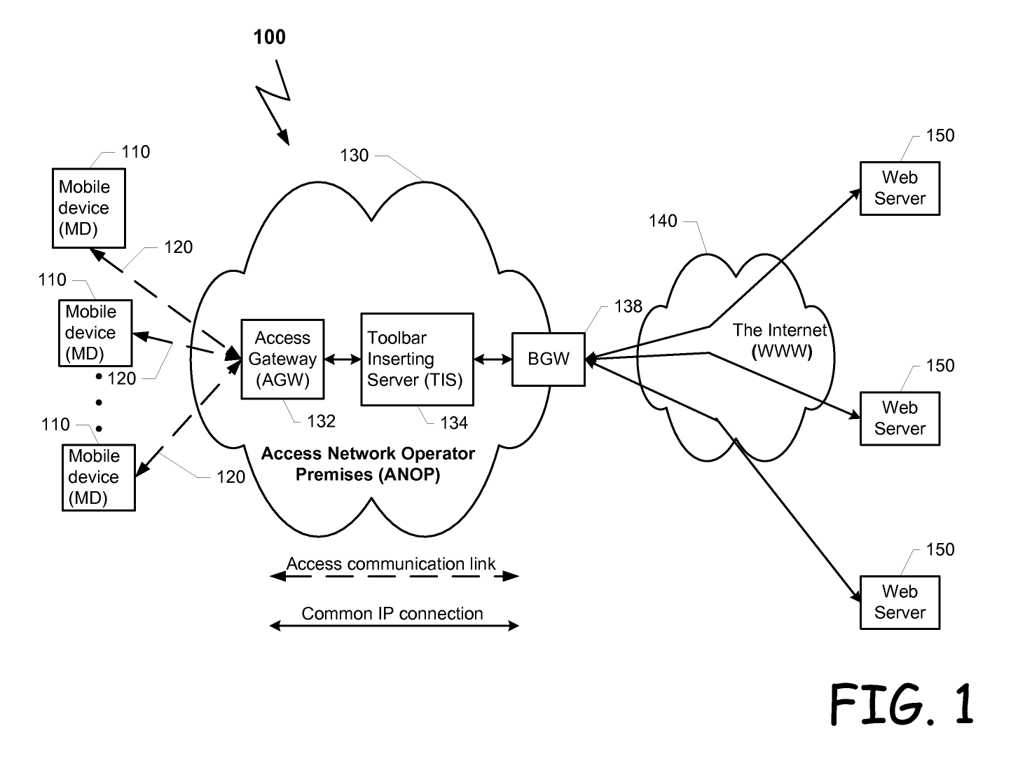

FIG. 1 depicts a block diagram with relevant elements of an exemplary communication system 100 that implements an exemplary embodiment of the present invention. A communication system 100 has been selected as an exemplary environment that is suitable for implementing exemplary techniques of various embodiments. The communications system 100 may be a cellular data communication network, satellite networks, access networks, Internet Service Provider (ISP), or other type of network or communication system. Within the context of this description, the terms cellular, satellites, wireless, and ISP may be used interchangeably and at times, may have the same meaning.

System 100 may comprise a plurality of mobile devices 110 (MD); an Access Network Operator Premises (ANOP) 130, a network 140 such as but not limited to the Internet, which can be referred also as the world wide web (WWW); and one or more Web Sites or web servers 150. An exemplary ANOP 130, among other elements, may comprise an access gateway (AGW) 132, a toolbar inserting server (TIS) 134 and a border gateway (BGW) 138. It should be noted that in the figure, the illustrated ANOP 130 only presents modules or elements that are relevant to the Internet protocol and to such embodiments utilizing the Internet protocol. However, the various embodiments may utilize other technologies and as such, the ANOP may be configured to support those technologies. Within the context of this description, the terms “content servers”, “web server”, “web site”, may be used interchangeably and at times, may have the same meaning.

It will be appreciated by those skilled in the art that, depending upon its configuration and the needs, system 100 may comprise any number of Web sites 150 and Mobile devices 110. However, for purposes of simplicity of understanding, three units of each are shown. It should be noted that the terms “mobile device”, “endpoint”, “client”, “surfer”, “user's device”, “client device” and “user” may be used interchangeably herein.

System 100 is illustrated as being based on the Internet Protocol (IP). It may represent one or more networks segments, including but not limited to one or more Internet segments, one or more Intranets, etc. System 100 may run over one or more types of physical networks, such as but not limited to, the Public Switched Telephone Network (PSTN), an Integrated Services Digital Network (ISDN), a cellular network, a satellite network, etc. System 100 may also run over a combination of two or more of these networks. System 100 may include intermediate nodes along the connection between a mobile device and a web site. The intermediate nodes may include, but are not limited to: IP service provider servers, cellular service provider servers and other type of service providers' equipments.

A plurality of mobile devices 110 may be served by the System 100 and be able to access the web sites 150 via the ANOP 130 and the Internet 140. A common mobile device 110 may run a browser software application in order to surf the network and to communicate with one or more web sites 150. An exemplary browser application may be MOBILE SAFARI (trademark of Apple inc.), ANDROID BROWSER (a Trademark of Google Inc.), and other browsers that support HTML. 5.0 and other versions, for example. An exemplary mobile device 110 may be an IPHONE, IPAD (trademarks of Apple Inc.), NOKIA X7-00 or NOKIA E6-00 (a trademark of Nokia Finland) or any other tablet computing device with communication capabilities that presents new features, such as the “Viewport” interface, for example.

The plurality of mobile devices 110 are connected via a plurality of communication links 120 to the Access Gateway (AGW) 132 within the ANOP 130. The connection between the mobile devices 110 and the ANOP 130 may be via intermediate nodes (such as but not limited to a base station) not shown in FIG. 1. The AGW 132 acts as an access gateway between the communication protocols that are used over communication links 120 and the IP network that is used over the ANOP 130. An exemplary AGW 132 handles the physical layer, data link layer, up until the network link layer. The AGW 132 forwards the IP packets received from the mobile device 110 toward the toolbar inserting server 134 (TIS), and vice versa. Exemplary AGW 132 may be a Remote Access Server (RAS), Gateway GPRS Support Node (GGSN), Packet Data Serving Node (PDSN).

Border Gateway (BGW) 138 is the interface between the Internet 140 and the ANOP 130. The BGW 138 may route the upload communication toward the appropriate destination over network 140. When the upload transportation is a request for web page, the BGW 138 routes the request to the appropriate web site 150. The terms BGW and the Border Router may be used interchangeably throughout this description. In the download direction, the BGW 138 receives incoming packets from the different web sites 150 and distributes them to the appropriate modules of the ANOP 130.

An exemplary embodiment of toolbar inserting server 134 (TIS) may process requests received from the plurality of MDs 110 via AGW 132, HTTP requests for example. Requests that are targeted toward the TIS 134 are handled by the TIS 134. Requests that are directed to other servers or domains 150 are transferred by the TIS 134 toward the final destination via the BGW 138, for example. The toolbar inserting server 134 (TIS) can identify the type of the MD and the browser capabilities thereof by parsing a user-agent field, for example. If the MD is a tablet device with Viewport functionality (IPAD, IPHONE, etc.), then the TIS 134 may further handle the call. If the MD is not a tablet device with Viewport functionality, then the TIS 134 just relays the communication to and from the MD 110 without manipulating it. In the other direction, the toolbar inserting server 134 (TIS) can parse the web pages (the ML files that describe the web-page) received from the web sites 150 via the BGW 138.

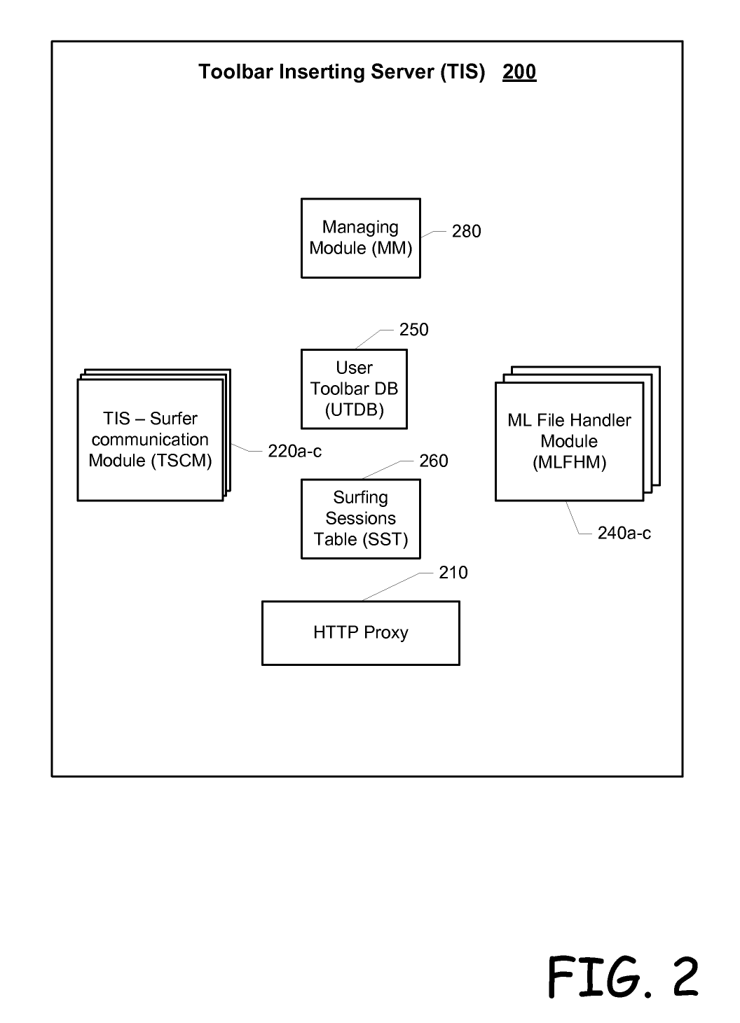

While processing a received ML file from one of the web servers 150, the TIS 134 may decide whether to insert the toolbar script and the US of the toolbar into the web page or whether to transfer the web page as is toward its destination—the requesting MD 110. The toolbar script, in some embodiments, may comprise one or more iframes. The TIS 134 may also manage and update or may be associated with databases (DB) and/or tables. The DB may contain information on the different subscribers and their mobile devices 110, as well as information on different websites 150. This information may include but is not limited to: the mobile device capabilities (browser, screen size, tablet, JavaScript support, etc.), information on the user such as toolbar, bookmark, etc. In some embodiments, the TIS 134 may be transparent to both sides of the connection, to the mobile devices 110 and\or to the web sites 150. Further, the TIS 134 may be configured to handle the cross domain communication between the TJS and the US and domains other than the domain of the TIS 134. More information on the operation of TIS 134 is depicted below in conjunction with FIGS. 2-5.

FIG. 2 is a block diagram illustrating relevant elements of a toolbar inserting server (TIS) 200 that operates according to an exemplary embodiment of the present disclosure. The TIS 200 may be communicatively coupled with an ANOP 130 (FIG. 1) in between the AGW 132 (FIG. 1) and the BGW 138 (FIG. 1). The TIS 200 may intercept and handle mobile device 110 requests received via the AGW 132 and targeted toward web servers 150 (FIG. 1) as well as toward the TIS 200 itself and web pages received in response to such requests from web servers 150 via the BGW 138.

An exemplary embodiment of a TIS 200 may comprise an HTTP proxy 210; one or more TIS-Surfer communication modules (TSCM) 220a-c, adapted to handle the communication between the MDs 110 (FIG. 1) and the TIS 200 itself; one or more ML File Handler Modules (MLFHM) 240a-c (adapted to handle ML files received from web sites 150 via the BGW 138); a user toolbar database (UTDB) 250; a surfing sessions table (SST) 260 stored in a memory device of the TIS 200; and a managing module (MM) 280. It will be appreciated by one of ordinary skill in the art that depending upon its configuration and the needs, the TIS 200 may comprise a number other than three of TSCM 220a-c, and MLFHM 240a-c. However, for purposes of simplicity of understanding, three units of each are shown.

In an exemplary embodiment of the present disclosure in which the communication between the modules of the ANOP 130 (FIG. 1) is based on the IP (Internet Protocol), HTTP proxy 210 can be adapted to handle the first four layers of the OSI seven layer communication stack. The layers can be the Physical Layer, Data Link Layer, Network Layer, and Transport Layer. In exemplary embodiments, the TIS 200 can be transparent to the mobile devices 110 (FIG. 1), as well as to the web pages 150 (FIG. 1). The HTTP proxy 210 may behave as a transparent proxy and may use a redirector, for example. In an alternate embodiment in which the TIS 200 can be configured as an HTTP proxy at the terminals 110 (FIG. 1), a redirector is not needed. The HTTP proxy 210 can be adapted to collect packets coming from the plurality of mobile devices 110 (FIG. 1) or web pages coming as responses from the web sites 150 (FIG. 1) and forward them into the internal modules of TIS 200 or toward their destination.

An exemplary HTTP proxy 210 can be adapted to get processed (modified) requests and/or responses from the internal modules of the TIS 200; arrange the processed requests and/or responses according to the communication protocols into IP packets and transfer the packets according to the destination address. The destination address can be the appropriate MD 110 via the AGW 132 (FIG. 1). Alternatively, the destination address can be the appropriate website 150 (FIG. 1) via the BGW 138.

HTTP requests coming from the mobile devices 110, via the AGW 132 (FIG. 1), may be intercepted by the HTTP proxy 210, which parses the destination address in order to determine how to handle the request. If the destination is the TIS 200, then the request can be transferred toward an appropriate TSCM 220a-c that handles the communication with the MD that sent the request. Responses from the relevant TSCM 220 may be processed by the HTTP proxy 210 according to the communication protocols and be transferred toward the relevant MD 110 (FIG. 1) via AGW 132 (FIG. 1).

If the destination of the HTTP request is one of the web servers 150 (FIG. 1), then the HTTP proxy may search the SST 260 looking for an entry that is associated with the source IP address of the request (i.e., a particular mobile device). If an entry is found, then the request is transferred toward its destination and a field in the entry that is associated with the receiving time can be updated. If an entry was not found, indicating that the request belongs to a new surfing session, then an entry in the SST 260 is allocated for handling information that is related to this new session. The source IP address can be written in one of the fields of the allocated new entry. Next, the user-agent field in the header of the HTTP request can be parsed in order to determine whether the requesting MD is a modern tablet device using a browser application that can handle HTML having Viewport capabilities or not.

If the requesting MD 110 is not a tablet device with Viewport capabilities, then an indication can be written into or associated with the entry, marking this session as a session without a toolbar and the request can be transferred toward its destination. If the requesting MD is a tablet device having Viewport capabilities, then a TSCM 220 and an MLFHM 240 may be allocated to handle the session and an appropriate indication on the allocated modules can be written in or associated with the new entry of the SST 260. The time field in the SST 260 entry, can be updated with the receiving time of the request and the request can be sent toward its destination. After sending the request, an indication can be transferred toward the MM 280, informing it about the new session and the allocated entry in SST 260. The MM 280 may apply to the ANOP 130 policy server or to an Authentication, Authorization and Accounting (AAA) server (both are not shown in the drawings) in order to obtain the identification number (ID) of the requesting MD in order to collect additional information about the surfer that uses the requesting MD and update the relevant entry in SST 260 accordingly.

ML files (HTML, for example) received from the web sites 150, via the BGW 138 (FIG. 1), can be intercepted by the HTTP proxy 210, which parses the destination address in order to find an entry in the SST 260 that is allocated to the surfing session of the destination address. By parsing the found entry, the HTTP proxy 210 can determine how to handle the received ML file. If the entry indicates that the relevant session is a session without a toolbar, then the received ML file can be transferred as is toward its destination. If on the other hand, the entry points on an allocated MLFHM 240, then the ML file is transferred toward the allocated MLFHM 240. A manipulated ML file that returns from the allocated MLFHM 240 is transferred by the HTTP proxy 210 toward the requesting MD 110 (FIG. 1) based on the destination address.

The Managing Module 280 can be initiated during power on of the TIS 200. During initiation, the Managing Module 280 (MM) can be introduced to the TIS 200 internal modules. Resources, which are relevant to the operation of the Managing Module 280, can be allocated and reset. Such resources include counters, clocks, timers, memory, etc. as non-limiting examples. The Managing Module 280 can be configured with different parameters such as, but not limited to the policy server of the ANOP 130 (FIG. 1) address, AAA server, ANOP databases, etc. The Managing Module 280 can allocate resources for each one of the internal modules of the TIS 200 (TSCM 220; SST 260; HTTP PROXY 210; and MLFHM 240, for example) and may initiate them.

During operation, the Managing Module 280 can monitor the operation of the TIS 200 and in cooperation with the HTTP proxy 210, it may create or release one or more TSCM 220a-c or MLFHM 240a-c. The allocated TSCM 220a-c and MLFHM 240a-c may be associated with an entry in the SST 260 that is allocated to the same session. The Managing Module 280 can include a UTDB 250 updating program. The updating program will be initiated from time to time by an administrator of ANOP 130 (FIG. 1) with updated information of user-agent types, URLs of user's toolbar, other server addresses for cross domain communication with the toolbar, etc. Those domains can be related to the user bookmark, for example. In an exemplary embodiment, the Managing Module 280 can include an SST 260 entry releasing program. An exemplary SST 260 entry-releasing-program can monitor the activity of each session. Upon determining that the session is idle or has ended, the relevant entry in the SST 260 table can be released. The decision can be based on the duration from the last transaction, for example. In an exemplary embodiment, if the duration from the last request is longer than few tens of minutes, 30 minutes for example, then the session can be defined as a terminated session and the resources allocated for that session in the SST 260 and/or TSCM 220a-c and/or MLFHM 240a-c can be released. In some embodiments, when a surfer disconnects, from the ANOP 130, the AAA server may inform the MM 280 that the surfer is not active any more. Based on this information, MM 280 may terminate the session and release the allocated resources.

Further, upon receiving an indication from the HTTP proxy 210 that a new session is started with a pointer to the entry allocated to the new session in the SST 260, the MM 280 based on the currently used IP address may apply to the policy server of the ANOP 130 or the Authentication, Authorization and Accounting (AAA) server (both are not shown in the drawings) in order to obtain the identification number (ID) of the MD 110. The communication with the AAA server can be based on an AAA protocol, such as but not limited to RADIUS. The identification number can be the “Mobile Subscriber Integrated Services Digital Network Number” (MSISDN) of the MD 110, for example. The obtained ID can be written in the appropriate field of the new entry in SST 260.

In addition, based on the obtained ID, the MM 280 can retrieve information about the user from the UTDB 250, which is related to the toolbar. The retrieved information can be written in the relevant fields of the new entry in SST 260. The relevant information can be the size of the display of the MD 110 in pixels W×H, the URL of: the toolbar iframes, US, TJS. In exemplary embodiments in which the communication between the US and the TJS code is based on “postMessage” cross window protocol, the communication can be based on an application program interface (API) may use a predefined authentication process. In such embodiments, the authentication key can be fetched from the UTDB. In addition, the URLs of web sites that are authorized to communicate with the TJS may also be obtained, etc.

The UTDB 250 can be one or more internal or external databases, a persistence memory, or any other type of computer data storage device for example. In some embodiments, the UTDB 250 can be located in the ANOP 130 and can communicate with the TIS 200. Each entry in UTDB 250 is associated with a subscriber, a user of the ANOP 130. The subscriber ID, such as the MSISDN, can be stored in one of the fields of the entry and be used as identifier of the entry. Each entry may include, among other things, fields like: user-agent field; mobile device capabilities (i.e., whether a mobile device 110 is a tablet MD, which browsers the mobile device 110 utilizes, the screen size, screen resolution, whether the screen is a touch screen, etc.). In addition, the entry may include fields that are associated with the subscriber's toolbar, fields for storing the authentication key of the TJS and the US, the URL of the toolbar one or more iframes of the subscriber, the URL of the subscriber US, and the TJS. Additional fields can store information related to cross domain communication, etc. Yet other fields can store information regarding the subscriber bookmark, promotion, etc. In some embodiments, certain fields can hold information regarding the servicing policy of the relevant subscriber, whether to offer the subscriber a toolbar or not, etc.

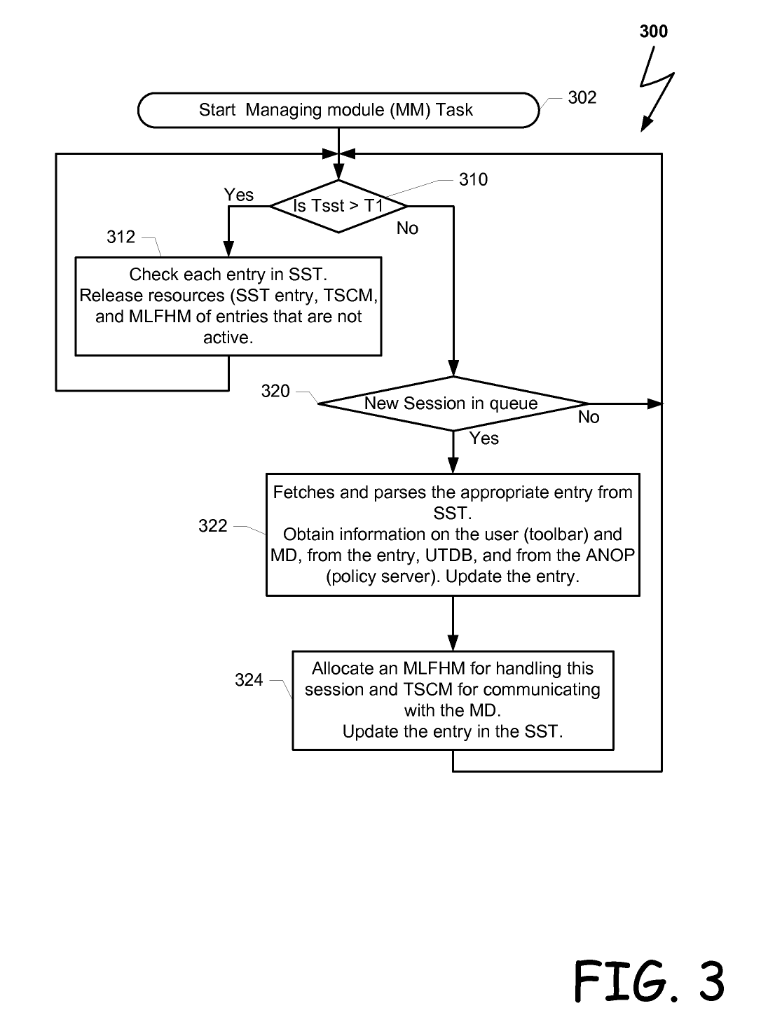

From time to time, the UTDB 250 can be configured by the administrator of the ANOP 130. In addition UTDB 250 can be updated by the MM 280 when an entry for a certain subscriber ID is not found in UTDB 250. The MM 280 may obtain the required information from the policy server (not shown in the drawing) of the ANOP 130. During or proximate to a surfing session, the UTDB 250 can be accessed by the MM 280 at the beginning of a new surfing session. The MM 280 may access the entry in the UTDB 250 of the surfer of the new surfing session in order to collect information to be loaded into the entry that was allocated for the new surfing session in SST 260. The SST 260 can be a random access memory (RAM) that holds the information stored in the UTDB 250 to be used for the current surfing sessions. In addition to the information collected from the UTDB 250, each entry in the SST 260 may store the current IP address used by the subscriber for the current session. More information on the operation of the MM 280 is depicted below in conjunction with FIG. 3.

An exemplary TSCM 220 may be capable of handling the communication between the MDs 110 and the TIS 200. Such communications are characterized in that it's destination address is the address of TIS 200. The TSCM 220 may handle requests that are targeted toward the TIS and takes care to respond to them. For example, common HTTP requests received from the browser while parsing a web page and related to the toolbar can be directed to the TIS 200. For example, the HTTP requests for fetching the US, the toolbar iframes, etc.

Other types of requests that are targeted toward the TIS 200 may be the AJAX request such as XML HTTP request (XHR) for cross domain communication received from the US or the TJS. The TSCM 220 may handle the cross domain AJAX communication (communication from the toolbar with other domain) by checking the relevant entry in SST 260, based on the source IP address of the request, whether the requested other domain is authorized to communicate with the toolbar. If yes, then the TSCM 220 may remove the cross domain prefix and add the address of the other domain and send the modified request via HTTP proxy 210. Responses from the other domain are handled by the TSCM 220 and are transferred toward the requesting MD 110 via HTTP proxy 210.

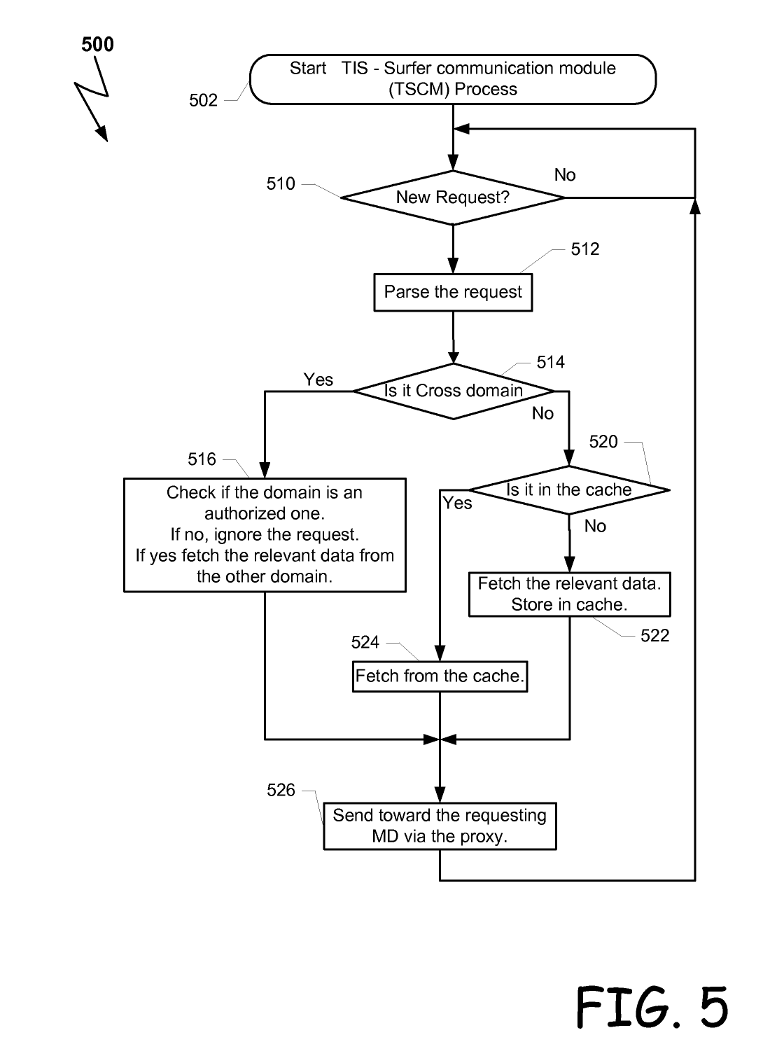

In an exemplary embodiment, the TIS 200 may have a plurality of TSCMs 220 that operate in parallel with each TSCM 220 being assigned to a certain surfing session. Yet in other exemplary embodiments, the TIS 200 includes a single TSCM 220 that can be used (not shown in the drawing) for handling a plurality of surfing sessions in serial. More information on the operation of the TSCM 220 is depicted below in conjunction with FIG. 5.

An exemplary MLFHM 240 can be capable of handling ML-files, such as but not limited to HTML files, that are transferred from the web sites 150 (FIG. 1) to mobile devices 110 (FIG. 1) via the TIS 200. An exemplary MLFHM 240 may receive, via the HTTP proxy 210, an ML file related to a certain surfing session. The MLFHM 240 can search the SST 260 for an entry storing information related to the toolbar that belongs to the surfer of that session. The information in the SST 260 may include, as a non-limiting example, information on the screen size of the MD 110, the URL of the toolbar script, (the URL of the iframes, for example) and the IJS, TJS, the authentication key for “postMessage” communication, bookmarks, etc.

The exemplary MLFHM 240 may search for the body element of the ML file. If the body element of the requested web page was not found, then the received ML file is transferred as is toward its destination via the HTTP proxy 210. If the body of the web page was found, then the MLFHM 240 may inject the one or more toolbar iframes as well as the US before the end-of-body tag, </body>. In an alternate embodiment, instead of inserting the IJS itself, a link with a URL to the relevant IJS can be inserted to the ML file. At the MD 110, when a requesting browser parses the ML file and reaches the inserted link, it will fetch the IJS code and execute it.

Before inserting the toolbar iframes, for each iframe, an exemplary MLFHM 240 may fetch the URLs that are needed to be written in that iframe. The URLs are personalized and therefore are stored in the entry in the SST 260 that is assigned to the current session and associated with a particular user and mobile device. In some embodiments, the authentication key for “postMessage” communication can also be inserted in each iframe before injecting the toolbar iframes into the body of the page. An exemplary MLFHM 240 may insert three iframes a link as the toolbar script. Three iframes are related to the toolbar presentation and the link is related to the US. The three iframes can include the iframe for the portrait toolbar, one for landscape and one for promotion, for example. Those iframes that related to the presentation of the toolbar are hidden by default and only made visible by the insertion script (US). When a toolbar is displayed, at every point of time, the US verifies that only one of the iframes is designated as the toolbar iframe, and only this iframe can be displayed. The modified ML file is transferred toward the requesting MD 110 via HTTP proxy 210.

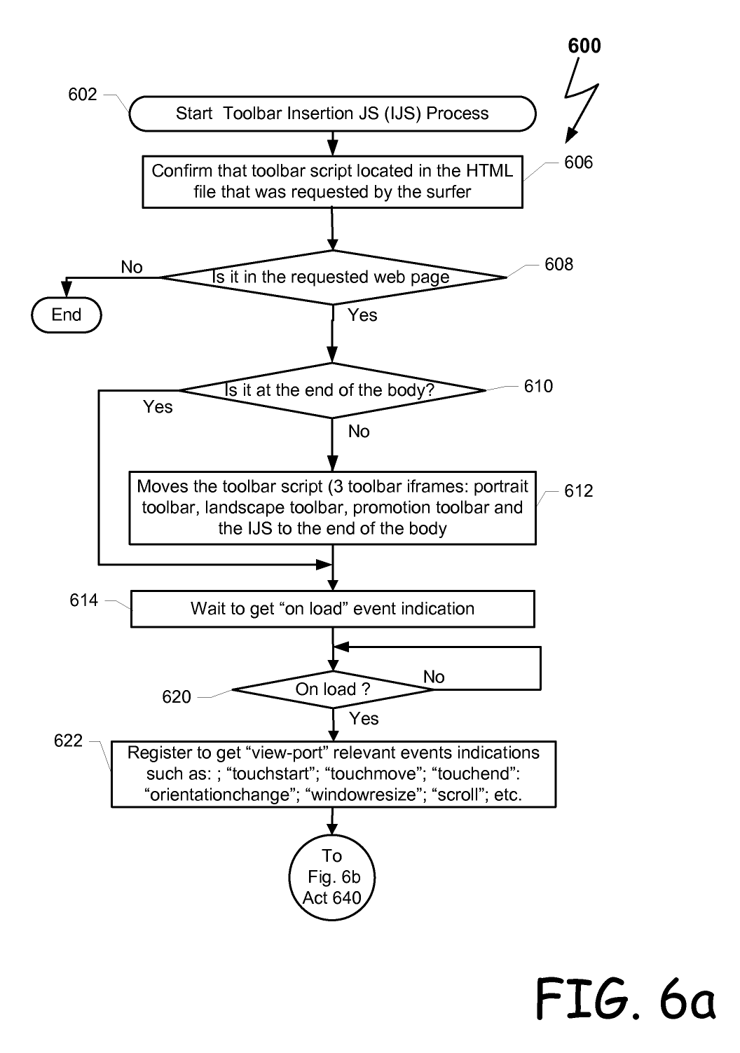

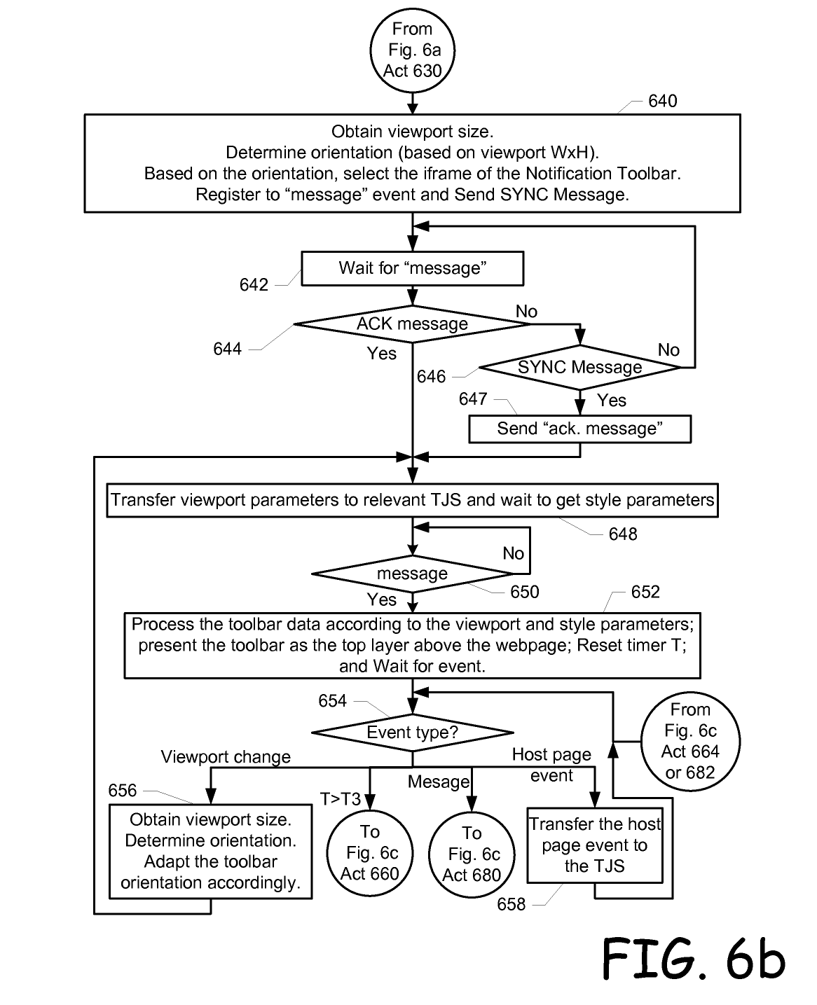

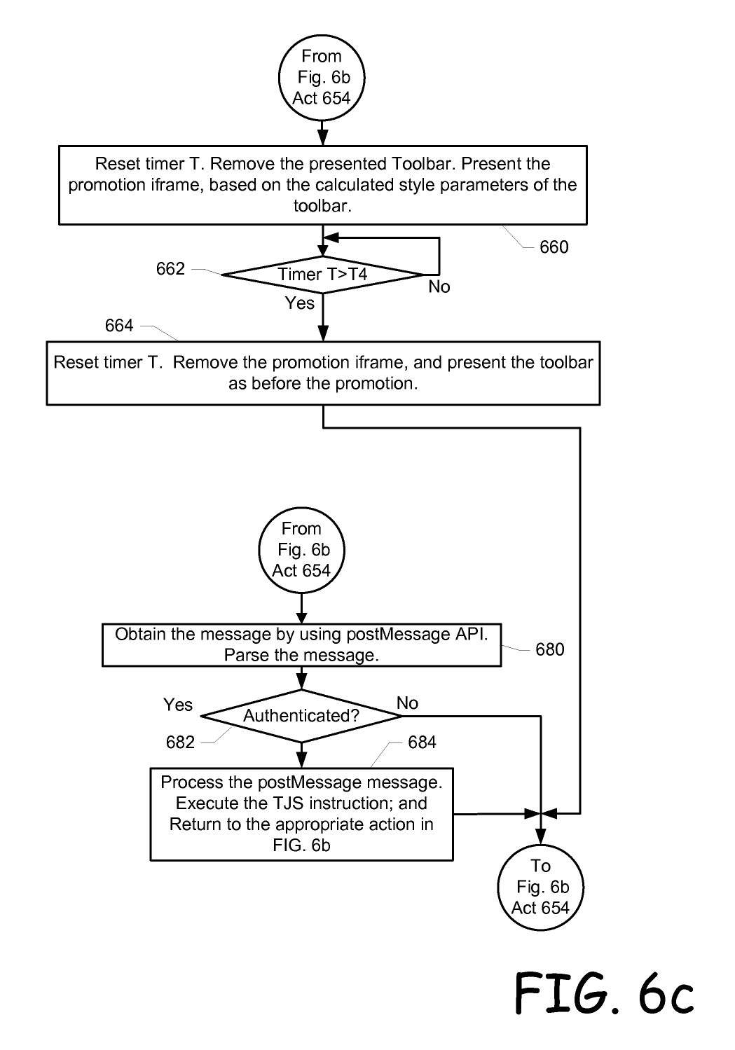

An exemplary embodiment of the TIS 200 may have a plurality of MLFHMs 240a-c that operates in parallel, and each MLFHM 240a-c can be assigned to a certain surfing session. Yet in other exemplary embodiments of the TIS 200, a single MLFHM 240 can be used (not shown in the drawing) for handling a plurality of surfing sessions one after the other (i.e., in serial). More information on the operation of the MLFHM 240a-c is depicted below in conjunction with FIGS. 6a-c.

FIG. 3 illustrates a flowchart with relevant actions of an exemplary process 300 for managing an exemplary TIS 200. The process 300 can be implemented by an exemplary MM 280 (FIG. 2). The process 300 can be initiated 302 during power on of the TIS 200. Among other activities, which are done during initiation, Managing Module 280 (MM) can allocate 302 resources, which are relevant to its operation. Resources such as counters, clock, timers; memory, etc. For example, Timer Tsst can be allocated and reset. Timer Tsst can be used for checking which sessions are inactive, for example.

Further, MM 280 can be configured 302 with different parameters such as, but not limited to the address of the policy server of the ANOP 130 (FIG. 1), AAA server, ANOP databases, etc. Managing Module 280 can allocate resources for each one of the internal modules of the TIS 200 (TSCM 220; SST 260; HTTP PROXY 210; and MLFHM 240, for example) and may initiate them.

After initiation 302, the value of the Tsst can be compared 310 to a predefine value T1. T1 can be in the range of few minutes to a few tens of minutes, 10 minutes as a non-limiting example. If the value of the Tsst is bigger than T1, then method 300 may check 312 which surfing sessions are not active. The MM 280 (FIG. 2) may parse each entry in the SST 260 looking for an entry in which the field of the time of receiving the last request indicates that the last request was received before a period which is longer than another predefined value, T2, of few tens of minutes, 30 minutes as a non-limiting example. Each such session may be defined as an inactive session and therefore the MM 280 can release 312 the resources which were allocated to that inactive session. These resources can include items such as the entry in SST 260, the allocated TSCM 220 and MLFHM 240, for example. At the end of the process, timer Tsst can be reset and method 300 can return to action 310. In some embodiments action 312 can be executed in the background while process 300 continues to action 320.

If the value of Tsst is less than T1, then the MM 280 may check 320 its queue, looking for an indication about a new session, which was received from the HTTP proxy 210. If there is no new session, the method 300 may return to action 310. If there is an indication with a pointer to the new entry in the SST, then the MM 280 may fetch 322, from the relevant entry, the IP address that is currently used by the MD 110 for the new session. Based on the fetched IP address, the MM 280 may apply 322 to the policy server of the ANOP 130 or to the AAA server in order to obtain the identification number (ID) of the MD. The communication with the AAA server can be based on an AAA protocol, such as but not limited to RADIUS. The identification number can be the MSISDN of the MD 110, for example. The obtained ID can be written in the appropriate field of the new entry in SST 260.

By using the mobile device ID as an index, the MM 280 can obtain 322 from the UTDB 250 (FIG. 2) information that is needed for the toolbar to be displayed on the relevant MD. The relevant information can be the size of the display of the MD 110 in pixels W×H, the URL of: the toolbar script (iframes), IJS, TJS, the authentication key, etc. The obtained information can be stored in the new entry of the SST 260. If the UTDB 250 (FIG. 2) does not have the required information, an exemplary MM 280 may apply to the policy servers of the ANOP 130 in order to collect the required information and update the UTDB 250 and the SST 260. However, if the policy servers cannot deliver the required information, then an indication can be written in the new entry that this new session is a session without a toolbar.

Next, at action 324, if a toolbar can be used, then the MM 280 may allocate an MLFHM 240 and a TSCM 220 for handling the communication with the new surfer. The allocated MLFHM 240 and a TSCM 220 can be associated with the new entry of the SST 260 that was allocated to the session. An indication that these resources have been allocated can be written in the new entry of SST 260 and method 300 may return to step 310.

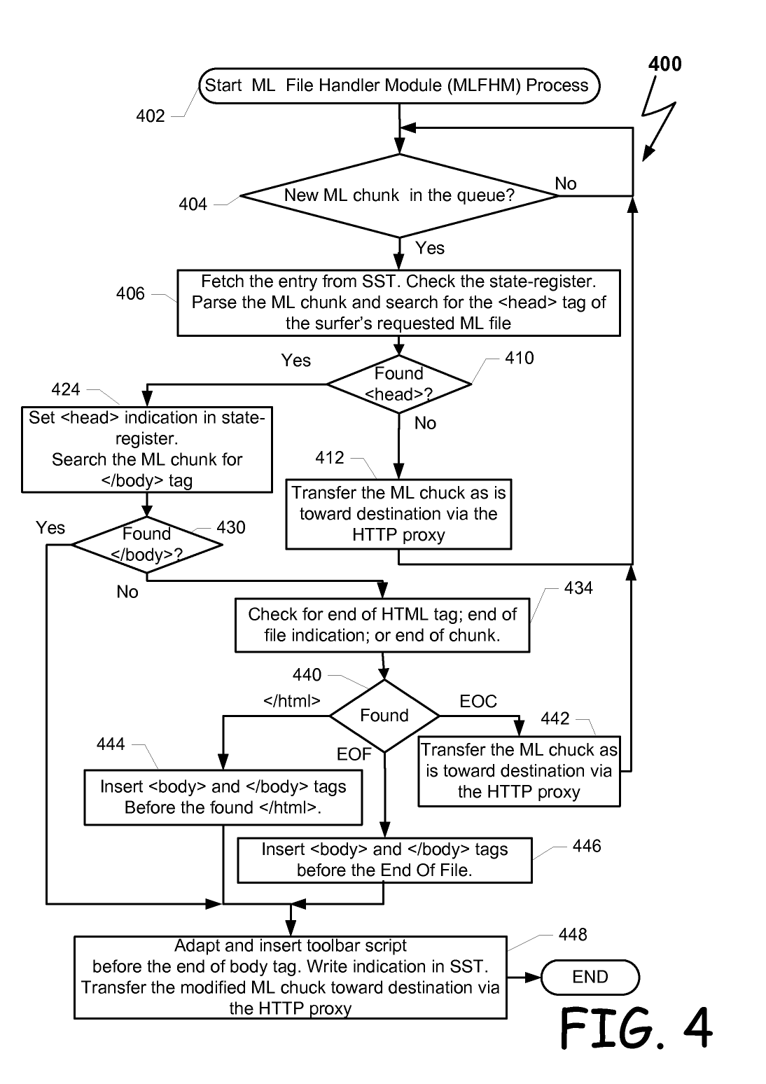

FIG. 4 illustrates a flowchart with relevant actions of an exemplary process 400 for handling an intercepted Markup Language (ML) file by an exemplary MLFHM 240a-c (FIG. 2). The process 400 can be initiated 402 by the MM 280 at action 324 (FIG. 3) while handling an obtained ML file of a new surfing session. Among other activities, which are done during initiation, the MLFHM 240 can reset a state register that is used during handling an ML file, for example. In some embodiment, the state register can be implemented by one or more fields of the relevant entry of the SST 260. After initiation, the process 400 may check 404 its queue, looking for a chunk of an ML file of the session and a pointer to the relevant entry in the SST 260 (FIG. 2), which was received from the HTTP proxy 210. A chunk of an ML file can be the entire ML file or any portion of the ML file that was received as a payload of a packet or a frame from a web server 150 (FIG. 1), for example. If the queue is empty, then the process 400 may wait 404 until an ML chunk is received.

If 404 an ML chunk exist in the queue, then the relevant entry from the SST 260 is fetched and the state register is checked 406 in order to conclude whether a head tag, <head>, was received in previous chunks of the ML file. If a head tag has not been received, then the received ML file chunk is parsed looking for the <head> tag. If 410 the <head> tag was not found, in the state register nor in the ML chunk, then the ML chunk is transferred 412 as is toward its destination via HTTP proxy 210 (FIG. 2) and the process 400 returns to action 404 looking for the next chunk. If 410 the <head> tag was found, in the state register or in the ML chunk, then the process 400 proceeds to action 424.

At action 424, the <head> indication is set in the state register and the received ML file chunk is parsed looking for the end of body tag, </body>. If 430 the </body> tag was found, then method 400 proceeds to action 448. During action 448, the MLFHM 240 collects information that is related to the toolbar from the entry in the SST 260. This information may include, but is not limited to: the URLs of the one or more iframes of the toolbar, the URL of the US, the size of the screen of the MD, the URL of authorized external domains for cross domain communication, authentication key words, etc. This related information is inserted into the toolbar script in the appropriate locations adapting the toolbar script to the subscriber (surfer) of the new surfing session. Then, the adapted toolbar script is inserted 448 before the end of body tag. The modified chunk of the ML filed is sent toward the MD 110 via the HTTP proxy 210 (FIG. 2) and an indication that the toolbar script was sent is written in the relevant field of the entry in the SST 260. Then the process 400 terminated.

If 430 the </body> tag was not found in the ML chunk, then process 400 may search 434 the received chunk looking for end of HTML tag, </html> or end of file indication, or end of chunk indication. If 440 a tag of end of HTML tag was found, </html>, then start and end of body tags, <body> and </body> respectively. can be inserted 444 before the end of HTML tag and the process 400 proceeds to action 448.

If 440 an indication on end of file (EOF) was found, then start and end of body tags, <body> and </body> respectively. can be inserted 446 before the end of the file and the process 400 proceed to action 448. If 440 the end of chunk is reached, then the ML chunk is transferred 442 toward its destination as is via HTTP proxy 210 and process 400 returns 442 to action 404 looking for the next chunk.

FIG. 5 illustrates a flowchart with relevant actions of an exemplary process 500 for handling the communication between a user device MD 110 (FIG. 1) and the TIS, according to teaching of the present disclosure. An exemplary process 500 can be implemented by a TSCM 220 while handling a subscriber's traffic that is targeted toward the TIS 200 (FIG. 2). An example of process 500 can be a thread that is executed by a processor that may be initiated 502 by MM 280 (FIG. 2) in response to an indication that a new session has been initiated. The new thread can be assigned to the new session. In alternate embodiment, a single process 500 can serve a plurality of MDs 110 that are connected via TIS 200.

After initiation, the process 500 may check 510 its queue, looking for a request received from its associated MD 110 via the HTTP proxy 210 (FIG. 2) and is targeted toward the TIS, the destination address of the request is the IP address of the TIS 200. If the queue is empty, then the process 500 may wait 510 until a request is received. The request can be an HTTP request received from the US while requesting one of the toolbar iframes, for example. The iframe can be the iframe that depicts the landscape toolbar, or the promotion, etc. Other types of request can be a cross domain request, which can be sent as XML HTTP requests (XHR) or a common HTTP request from the TJS via the HTTP proxy 210.

If 510 a request exists in the queue, then the request is parsed 512 and a decision is made 514 whether the request is a cross domain request or a common HTTP request received from the browser targeted toward the TIS domain. If 514 the request is a cross domain request received from the toolbar iframe at the associated MD 110, then the TSCM 210 may check 516 with the entry in the SST 260 which is allocated to the relevant session, looking for the fields that store the domain names of the authorized sites that are allowed to communicate with the TJS. If 516 the requested cross domain is not included in the authorized domains, then the request is ignored.

If 516 the cross domain is included in the list of the authorized domains, then the process 500 converts the cross domain request into a regular HTTP request targeted toward the allowed domain. The source IP address of the converted request can be the IP address that points on the relevant TSCM 210 and the converted request is transferred via the HTTP proxy 210 toward the cross domain. The response from the cross domain, which is targeted toward the relevant TSCM 220 is transferred via the HTTP proxy toward the TSCM 220. The TSCM 220 that changes the destination address and sends 526 the response via the HTTP proxy 210 toward the requesting MD 110.

Returning now to action 514, if the request is not a cross domain request, then 520 a decision is made whether the response to the request, a requested iframe of a toolbar for example, is in the cache of the TIS 200. The cache may be a part of the UTDB 250 (FIG. 2), or a separate cache machine, for example. If 520 the response in the cache, then the response to the request, one of the toolbar script iframes for example, is fetched 524 from the cache and is transferred 526 toward the requesting MD 110 via the HTTP proxy 210. Then the process 500 returns to action 510 looking for the next request in the queue. If 520 the response is not in the cache, then the TSCM 210 may fetch 522 the response from the appropriate server in the ANOP 130 (FIG. 1). The response may be stored 522 in the cache of the TIS 200 and be transferred 526 toward the requesting MD via the HTTP proxy 210. Then the process 500 returns to action 510 looking for the next request in the queue.

FIGS. 6a to 6c illustrate a flowchart with relevant actions of an exemplary process 600 that can be implemented by a browser application running an exemplary IJS at an MD 110 (FIG. 1) while parsing an ML file, such as an HTML file for example. The HTML file was manipulated by an exemplary MLFHM 240 of the TIS 200 (FIG. 2). The process 600 may be initiated 602 while the browser reaches the injected IJS in the manipulated HTML file. In some embodiments, the browser may reach an injected link with a URL that points on the IJS. In such embodiment the browser may fetch the US and start executing 602 it.

After initiation IJS may check the Document Object Model (DOM), associated with the requested web page, in order to confirm 606 that the toolbar script and the IJS are located in the body of the requested web page and not in an internal iframe of the requested web page. If 608 the toolbar script and the US are not located in the body of the request web page, the process 600 may terminate and the toolbar will not be presented over that modified ML file.

If 608 the toolbar script and the US are located in the body of the requested web page, then a decision is made whether 610 the US and the toolbar script are the last elements in the body. If the toolbar script and the IJS are the last elements in the body 610, then the process 600 proceeds to action 614. If 610 the toolbar script and/or the US are not the last elements of the body, then the US may move 612 the one or more iframes of the toolbar script to the end of the body.

At action 614 the IJS may register for being notified when the browser completed the presentation of the requested web page. The IJS is registered to obtain the “on load” event indication. Then, the US may wait 620 for obtaining the “on load” indication. Upon 620 receiving the “on load” indication, the IJS may register 622 to be notified when a certain event occurs (i.e., events that can affect the presentation of the toolbar). Exemplary events can be touch events (touch-start, touch-end) for showing/hiding the toolbar, showing/hiding the promotion toolbar. Other events can include: changes in the Viewport such as size changes, scrolling the Viewport, orientation changes, etc. Then the process 600 proceeds to action 640 in FIG. 6b.

In some embodiments, the US may automatically present 640 a notification toolbar over the presented web page. The notification toolbar may present a toolbar icon, at a corner of the screen for example. The icon may prompt the surfer to gesture on the icon in order to present the surfer's toolbar. In an alternate exemplary embodiment, the notification toolbar may be a text message informing the surfer to swipe on any location on the screen in order to present the surfer's toolbar. In some embodiments the notification toolbar can be described by the promotion iframe. Other embodiments of TIS 200 (FIG. 2) may insert additional two iframes (portrait and landscape) that are dedicated to the notification toolbar.

In order to show the notification toolbar, the IJS may obtain 640 from the browser the viewport size W×H and according to the ratio between the width and the height may determine the orientation of the MD. In addition, information on the location of the top left corner of the viewport, in pixels from the top left corner of the canvas of the presented webpage is collected from the browser. Based on the orientation the appropriate iframe of the notification toolbar (or the promotion iframe in other exemplary embodiments) is selected. During parsing the notification toolbar iframe, the associated TJS can be activated.

In order to synchronize the two JS codes (IJS and the TJS) the US may register to receive an indication that a “postMessage” event has been sent over a cross window protocol. After being registered, the IJS may send 640 a SYNC (Synchronizing) message over the cross window protocol. An exemplary SYNC message may be a prefix of the TIS and the word up, TIS_up for example. At this point of time the process 600 may wait 642 for receiving indication on a message event.

Upon receiving an indication on a message event, the message is parsed in order to determine 644 whether it is an acknowledge (ACK) message. An exemplary ACK message can be in the form of TIS_up_ack for example. If 644 the message is an ACK message, then the process 600 proceeds to action 648. If 644 the message is not and ACK, then a decision is made whether the message is a SYNC message, which was sent from the TJS. If 646 the message is not a SYNC message, then the process 600 returns to action 642 waiting for the next message event. If 646 the message is a SYNC message, then the IJS may send 647 an ACK message and proceed to action 648.

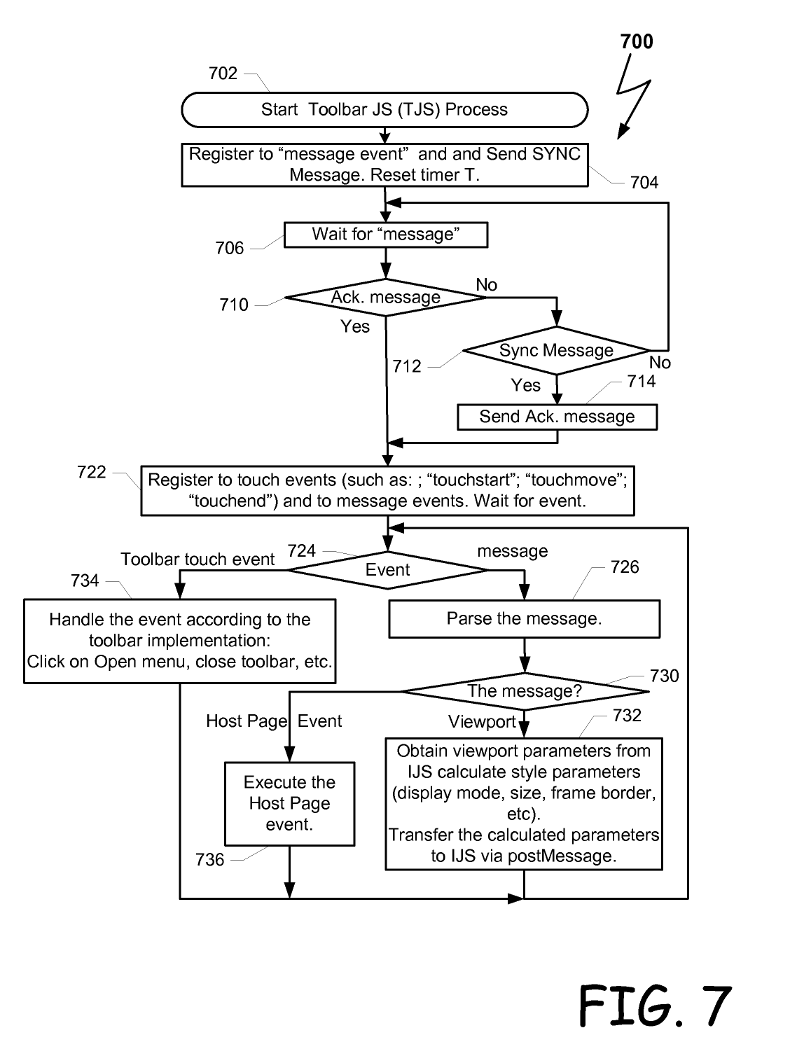

At action 648, the IJS may send to the TJS, based on the cross window protocol (postMessage), the viewport size and the location of the top left corner related to the canvas of the web page. The TJS may process the information (see FIG. 7) in order to position the toolbar over the viewport and resize it. The calculated information is sent back from the TJS to the US as style properties. After sending 648 the information on the viewport, the US may wait 650 to get a cross widow message event received from the TJS and having the predefine prefix such as TIS prefix. Yet in an alternate exemplary embodiment, the US may process the obtained information regarding the viewport size and the location of the top left corner related to the canvas of the web page in order to determine the position of the toolbar over the viewport and resize it. In such embodiments actions 648 and 650 are not needed.

Upon 650 obtaining the calculated style parameters the IJS may process the iframe of the toolbar based on the calculated style parameters and presenting 652 the toolbar as the top layer. The drawing stack order of the iframe of the toolbar will be defined as the top layer, for example. The size of the toolbar can be the size of the viewport, while most of it may be transparent and only a small portion of the viewport, 5-15% for example, at the top or the bottom of the toolbar can present the toolbar content. After presenting the toolbar, the US may reset 652 a timer T and wait for event. Yet in some embodiments the toolbar layer can be smaller than the viewport, or the content can be presented in other sections of the toolbar layer.

Upon receiving an indication of an event 654 a decision is made whether the event is one of the following types of events: cross window message, time event, viewport event and host page event. If the event is a cross window message received from the TJS, then the US may proceed to action 680 in FIG. 6c. If 654 the event is time event, in which the value of timer T is bigger than a pre define period of time, T3 for example, then the process 600 proceeds to action 660 in FIG. 6c. If the event is viewport event, then the IJS may obtain 656 from the browser the viewport parameters and determine the orientation of the viewport.

The toolbar orientation is adapted 656 to the orientation of the viewport. If the orientation of the viewport was not changed, then the visible toolbar iframe remains as before the change and the new size and location parameters of the viewport are transferred 648 to TJS. If the orientation has been changed, then the visible toolbar iframe is made invisible 656 and the other toolbar iframe that fits the new orientation is modified by the IJS to be visible and the new size and location of the viewport is transferred 648 to the TJS via the cross window protocol (postMessage for example). Yet in some embodiments the IJS may process the obtained information in order to determine the position of the toolbar over the viewport and resize it. In such embodiments, actions 648 and 650 are not needed and method 600 may return to action 652. If the event is a host page event 658 that is related to the toolbar, then the IJS may process the event according to the API and transfer it toward the TJS. An exemplary host page event that is related to the toolbar can be pulling a word from the host page into the toolbar area for translation. After transferring the information to the TJS, method 600 returns to action 654 waiting to the next event,

Referring now to FIG. 6c action 660, this action is reached when timer T is greater than T3, indicating that a promotion can be presented instead of the toolbar. The value of T3 can be a configurable value in the range of few minutes to few tens of minutes as a non-limiting example. At this point, the timer can be reset 660. The current presented iframe is made invisible and the promotion iframe that complies with the same orientation can be presented. Presenting the promotion toolbar can be based on the same style parameters that were used to present the toolbar. The US may wait 662 until the value of timer T is greater than T4, wherein T4 can be a configurable period shorter than T3 and can be in the range of few minutes, as a non-limiting example.

After T4, the timer may be reset 664, the promotion iframe can be modified to invisible and the previously presented toolbar iframe can be modified to be visible again and the process 600 may return to action 654 in FIG. 6b and waits for event. It should be understood in other embodiments, rather than using a timer, or in conjunction with using a timer, a viewport event may also be used to trigger the removal of the promotion. For instance, the promotion may include a soft button that can be selected, such as an (X) to have the promotion removed, or the like.

If 654 (FIG. 6b) the event is a cross window message, then at action 680 (FIG. 6c) the message is fetched by using a postMessage API, for example. Other embodiments may use other types of APIs and protocols. The message is then parsed. In embodiments in which authentication is used, then based on the key parameter, which is part of the iframe, the sender of the message is authenticated. If 682 the authentication fails, then the message is ignored and the process will return to action 654 FIG. 6b waiting for the next event.

If 682 the authentication succeeds, then the message is processed 684 based on the postMessage protocol and the instruction received from the TJS is executed. The instruction can indicate that the surfer touched the toolbar and pressed one of the button (icons), the toolbar icon, for example, requesting to present the toolbar. Other buttons can indicate a request to remove the toolbar, request to present the promotion toolbar, etc.

If the message was touching the toolbar icon in a presented notification toolbar, then US may modify the notification toolbar into an invisible iframe. Next the toolbar iframe that complies with the orientation of the viewport can be modified into a visible iframe. Presenting the toolbar iframe can be based on the same style parameters that were used to present the notification toolbar. After presenting the toolbar, the IJS may return to action 654 in FIG. 6b and wait for the next event.

FIG. 7 illustrates a flowchart with relevant actions of an exemplary process 700 of a toolbar JS (TJS) that can be implemented by a browser application running an exemplary TJS at an MD 110 (FIG. 1) while presenting a web page that is described by an ML file, such as HTML file for example. The HTML file was manipulated by an exemplary MLFHM 240 of TIS 200 (FIG. 2). The process 700 may be initiated 702 while the browser parses a visible iframe of a toolbar and reaches the injected TJS. In some embodiments, the browser may reach an injected link with a URL, which points on the TJS. In such embodiments, the browser may fetch the TJS and start executing 702 the TJS.

After initiation, the TJS may start synchronizing the two JS codes (IJS and the TJS) the TJS may register to receive an indication that a “postMessage” event has been sent over a cross window protocol. After been registered, the TJS may send 704 a SYNC. (Synchronizing) message over the cross window protocol. An exemplary SYNC message may be similar to the one that is disclosed above in conjunction with FIG. 6b. The SYNC message may have a prefix such as the TIS and the word up, TIS_up for example. At this point, the process 700 may wait 706 for receiving indication on a message event.

Upon receiving an indication on a message event, the message is parsed in order to determine 710 whether it is an acknowledge (ACK) message. An exemplary ACK message can be in the form of TIS_up_ack. If 710 the message is an ACK message, then the process 700 proceeds to action 722. If 710 the message is not and ACK message, then a decision is made 712 whether the message is a SYNC message, which was sent from the IJS. If 712 the messaged is not a SYNC message, then the process 700 returns to action 706 waiting to the next message event. If 712 the message is a SYNC message, then the IJS may send 714 an ACK message and proceed to action 722.

At action 722, the TJS may register to obtain message events and touch events in the area of the toolbar, and process 700 may wait 724 for an event indication. The touch event may be such as “touchstart”; “touchend”, etc. Upon 724 receiving an indication of an event, the indication is processed and a decision is made whether the event is a message or a touch event. If the event is a touch event the process 700 may proceed to action 734.

If 724 the event is a message event, then the message is parsed 726 and a decision is made whether 730 the message includes viewport parameters received from the US or an instruction received from the host page via the TJS. If 730 the message is a viewport event, then the viewport parameters are processed 732 in order to determine the style properties of the toolbar layer. Exemplary viewport parameters are disclosed in Table 1 below. Please note that “page pixels” may refer also to “canvas pixels”.

TABLE 1
Viewport parameters.

| Name | Description |
|---|---|
| viewportHeight | Height the viewport in “page pixels” |
| viewportWidth | Width the viewport in “page pixels” |
| viewportLeft | The distance between the left edge of the |
| | viewport and the left edge of the page. |
| viewportTop | The distance between the left edge of the |
| | viewport and the left edge of the page. |

From the above obtained Viewport parameters, an exemplary TJS may calculate 732 the location (top left corner) of the toolbar in relation to the top left corner of the page as well as size of the toolbar. Table 2 and Table 3 below represent exemplary way to define those style properties for portrait mode and landscape mode respectively.

TABLE 2
Toolbar Style Setting for Portrait mode.

| Style | | |
|---|---|---|
| Property | Description | Target value |
| width | The width of the toolbar frame in page pixels | viewportWidth |
| height | The height of the toolbar frame in pixels | $\frac{viewportWidth \times PORTRAIT\_TOOLBAR \_HEIGHT}{PORTRAIT\_TOOLBAR \_WIDTH}$ |
| marginTop | Margin between the toolbar frame and any other element (in practice the top of the page) | $\frac{\begin{matrix}viewportLeft + viewportHeight - \\ viewportWidth \times PORTRAIT\_TOOLBAR \_HEIGHT\end{matrix}}{PORTRAIT\_TOOLBAR \_WIDTH}$ |
| left | Distance between the toolbar left edge and the page left edge | viewportLeft |

TABLE 3
Toolbar Style Setting for Landscape mode.

| Style | | |
|---|---|---|
| Property | Description | Target value |
| height | The width of the toolbar frame in page pixels | viewportHeight |
| width | The height of the toolbar frame in pixels | $\frac{viewportHeight \times LANDSCAPE\_TOOLBAR \_WIDTH}{LANDSCAPE\_TOOLBAR \_HEIGHT}$ |
| marginTop | Margin between the toolbar frame and any other element (in practice the top of the page) | viewportHeight |
| left | Distance between the toolbar left edge and the page left edge | viewportLeft |

The TOOLBAR HEIGHT and TOOLBAR WIDTH represent the size of the toolbar and are embedded in the toolbar iframe. Units are not mandatory because a ratio is used. In some exemplary embodiments, also the ratio may be stored as one of the parameters of the surfer's MD 110 (FIG. 1) that are embedded in the iframe. An exemplary toolbar size can be equal to the viewport size while most of it is transparent and only a portion of it is used to present the toolbar. Fonts in the toolbar area can be manipulated in a similar way to the height of the portrait toolbar or the width of the landscape toolbar, depending on the current orientation of the MD. The calculated style setting is processed according to the postMessage protocol and is sent 732 toward the IJS. After sending the calculated style setting the process 700 may return to action 724 wait for the next event.

Yet, in an alternate exemplary embodiment, in which the IJS calculates the changes in the style parameters due to the changes in the viewport, the calculation that are disclosed above in conjunction with action 732 can be done by the IJS and not by the TJS. In such embodiment method 700 may proceed from action 726 directly to action 736.

In action 736 the TJS may execute a Host Page event. An exemplary Host Page event can be pulling a word from the host page to a translation icon in the toolbar. Upon receiving such a host page event, the TJS may send the word to a translation server, via a cross domain message, for example. Upon receiving the translation, the TJS may transfer the translation to the US via the postMessage API to be presented in the host page in adjacent to the word that was pulled. After executing the Host Page event the process 700 may return to action 724, waiting to the next event.

Returning now to action 724, if the event is touch event in the toolbar area, then the TJS processes the event and acts 734 accordingly. For example, if the event is touching on a certain button in the toolbar, such as close toolbar, for example. Then the TJS may send 734 a message to the US using the postMessage API. If the indication is touching a button for requesting information, for example, then a cross domain message XHR may be prepared by the TJS that includes the requested URL. The cross domain message may be sent 734 by the TJS toward the TIS 200 (FIG. 2) that first authenticated the requested domain as an authorized domain and then converts the cross domain message into a common HTTP request. The common HTTP request is sent toward the requested domain. After handling the touch event, the process 700 may return to action 724 and waits for the next event.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

Although some of the following description is written in terms that relate to software or firmware, embodiments may implement the features and functionality described herein in software, firmware, or hardware as desired, including any combination of software, firmware, and hardware. In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. Software of a logical module may be embodied on a computer readable medium such as a read/write hard disc, CDROM, Flash memory, ROM, or other memory or storage, etc. In order to execute a certain task a software program may be loaded to an appropriate processor as needed.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

What is claimed is:

1. A method for inserting a toolbar into a web page requested by a user of a mobile device, the method comprising the actions of:
receiving a markup language (ML) file that is transferred from a web server toward the mobile device, as the result of a request sent by the mobile device;
modifying the received ML file by inserting one or more toolbar scripts (TS) into the obtained ML file, wherein the one or more toolbar scripts are associated with an insertion scripting language code (US);
sending the modified ML file toward the mobile device;
wherein the mobile device has viewport functionality and the toolbar presentation is responsive to the viewport functionality.

2. The method of claim 1, wherein the action of inserting one or more toolbar scripts further comprises the action of setting the one or more toolbar scripts to be initially invisible.

3. The method of claim 1, wherein the action of receiving an ML file further comprises receiving an HTML file.

4. The method of claim 1, wherein the mobile device includes a touch screen and further comprising the action of the toolbar script executing on the mobile device detecting actuations of the touch screen.

5. The method of claim 4, wherein in response to actuations of the touch screen, the toolbar script operating to modify the toolbar.

6. The method of claim 1, further comprising associating a toolbar scripting language code (TJS) with the modified ML file.

7. The method of claim 6, wherein the action of associating a toolbar scripting language code (TJS) with the toolbar scripts further comprises the action of embedding a link in the toolbar script.

8. The method of claim 6, wherein the MD includes a touch screen and the TJS, while operating in the MD, is configured to detect actuations of the touch screen in the toolbar area.

9. The method of claim 6, wherein the TJS, while is operating in the surfer's MD, is configured to communicate with domains other than the domain of the toolbar by using cross domain communication.

10. The method of claim 1, wherein the action of inserting the one or more toolbar scripts into the ML file further comprises inserting one or more iframes into the ML file.

11. The method of claim 1, wherein the action of inserting one or more toolbar scripts into the ML file further comprises the action of inserting one or more toolbar scripts that comprise information related to the size of the screen of the mobile device.

12. The method of claim 1, wherein the toolbar script comprises a link to a portrait toolbar script that is used while the mobile device is operated in a portrait mode.

13. The method of claim 1, wherein the toolbar script comprises a link to a landscape toolbar script that is used while the mobile device is operated in a landscape mode.

14. The method of claim 1, wherein the toolbar script comprises a link to a promotion toolbar script.

15. The method of claim 1, wherein associating the insertion scripting language code (US) to the modified ML file is performed by inserting a link to the US in the modified ML file.

16. The method of claim 1, wherein the IJS, while executing in the mobile device, is configured to:
obtain parameters of the current viewport and, based on the obtained parameters determine the orientation mode of operation of the mobile device; and
present the toolbar as the top layer over the presented webpage to fit the obtained parameters of the current orientation of the viewport.

17. The method of claim 16, wherein the IJS, while executing in the mobile device, is further configured to detect changes in the viewport and further:
obtain parameters of the current viewport and, based on the obtained parameters determine the orientation mode of operation of the mobile device; and
present the toolbar as the top layer over the presented webpage to fit the obtained parameters of the current viewport.

18. The method of claim 16, wherein the US, while executing in the mobile device, is further configured to obtain instructions from the TJS via the cross window messaging mechanism and execute the instructions.

19. The method of claim 18, wherein the instruction received from the TJS is to remove the toolbar, the US makes the toolbar invisible.

20. The method of claim 1, wherein the US modifies a TS to be visible only if it located in the ML file that depicts the user requested webpage.

21. The method of claim 16, wherein action of obtaining the parameters of the current viewport comprise obtaining the size and position of the viewport.

22. A toolbar inserting server (TIS), comprising:
(a) a surfing-session table (SST) that comprises a plurality of entries with each entry being associated with a surfing session and each entry containing information related to a user of a mobile device (MD) that participates in the surfing session, and information related to one or more toolbars to be used by the user;
(b) a markup language (ML)-file-handler processor that is configured to:
modifying an obtained ML file that is transferred from a web server toward the MD, wherein the modification is done based on information stored in the SST in an entry that is associated with the user;
transferring the modified ML file toward the MD;
wherein the modified ML file comprises one or more toolbar scripts (TS) that are associated with an insertion scripting language code (US); and
(c) a TIS-surfer-communication processor that is configured to handle requests that are received from the MD and are targeted toward the TIS;
wherein the MD has viewport functionality and the toolbar presentation is responsive to the viewport functionality.

23. The TIS of claim 22, wherein the SST further contains information related to the mobile device (MD) used in the session.

24. The TIS of claim 22, wherein the modified ML file is further associated with a toolbar scripting language code (TJS).

25. The TIS of claim 22, wherein handling requests that are crossed domain requests received from the TJS and targeted to a domain other than the TIS domain, comprises
authenticating the other domain as an authorized domain; if not authorized, the request is ignored and if an authorized domain, the request is converted to common HTTP request and is transferred toward the other domain.

26. A non-transitory storage medium readable by a processor and storing instructions for execution by the processor, wherein when executed by the processor, performs a method for inserting a toolbar into webpage transferred to a mobile device having a touch screen, the method comprising the actions of:
obtaining a markup language (ML) file that is transferred toward a mobile device (MD);
modifying the obtained ML file by inserting one or more toolbar scripts (TS) into the obtained ML file, wherein the toolbar scripts are associated with an insertion scripting language code (US);
sending the modified ML file toward the requesting MD;
wherein the requesting MD has viewport functionality and the toolbar presentation is responsive to the viewport functionality.

27. The non-transitory storage medium of claim 26, wherein instructions for modifying the obtained ML file further comprising instructions for associating a toolbar scripting language code (TJS) with the modified ML file.

28. The non-transitory storage medium of claim 26, further storing instructions for execution by a processor in the surfer MD running the US and performing a method comprising the actions of:
obtaining parameters of the viewport and, based on the obtained parameters determining the orientation mode of the MD; and
presenting the toolbar as the top layer over the presented webpage to fit the obtained parameters of the current viewport.

29. The non-transitory storage medium of claim 27, further storing instructions for execution by a processor in the MD running the TJS and performing the action of handling actuations of the touch screen in the toolbar area.

30. The non-transitory storage medium of claim 27, further storing instructions for execution by a processor in the surfer MD running the TJS and performing a method comprising communicating with domains other than the domain of the toolbar by using cross domain communication.
